(19) United States
(12) Patent Application Publication
(10) Pub. No.: US 2006/0132812 A1
(43) Pub. Date: Jun. 22, 2006

(54) Automated wysiwyg previewing of font, kerning and size options for user-selected text

(75) Inventors: Craig Wallace Barnes, Portland, OR (US); Timothy Joel Brown, Hillsboro, OR (US); Eric Jon Hayes, Tigard, OR (US)

Correspondence Address: STOEL RIVES LLP, 900 SW FIFTH AVENUE, SUITE 2600, PORTLAND, OR, 97204-1268, US

(73) Assignee: You Software, Inc., Portland, OR (US)

(21) Appl. No.: 11/015,572

(22) Filed: Dec. 17, 2004

(51) Int. Cl. G06K 15/02

(52) U.S. Cl. 358/1.11

(57) ABSTRACT

A font control application detects a user selection of text being edited in a text-editing application. In response to a single user command, the font control application presents a font preview menu including the selected text automatically rendered multiple times in different fonts. In response to receiving a user selection of one rendition of the selected text from the font preview menu, the font control application instructs the text-editing application to change a font of the selected text to the font of the selected rendition.

### TECHNICAL FIELD

The present invention relates generally to the field of data processing. More specifically, the present invention relates to techniques for comparing and selecting text attributes, such as font, kerning, and size.

### BACKGROUND OF THE INVENTION

Most word processors allow users to select different fonts for displayed or printed text. Frequently, however, users are faced with the daunting task of selecting from literally hundreds of different fonts, with little more than a cryptic name, such as “Book Antiqua” or “Trebuchet MS,” to aid in the selection process. In many cases, a font must be first applied to a block of text in order to see what it looks like. Unfortunately, manually applying each available font the same block of text can be an extremely slow and tedious way to decide upon a font.

More recently, as illustrated in FIG. 1, Microsoft Word™ and other word processors have included font preview menus 100 that display the names of available fonts in their respective fonts. Thus, the name “Arial” is displayed using the Arial font, the name “Century” is rendered in the Century font, and so on. This provides users with some idea of how a particular font will appear without having to actually apply it to selected text. Unfortunately, such font preview menus 100 are limited in a number of respects.

Initially, the font names are too short to provide users with a representative sample of upper and lower case letters in the respective fonts. For example, the font name “Arial” only includes four unique letters and one upper/lower case combination. Accordingly, users may still be tempted to apply multiple fonts to a more representative sample of text in a document.

Moreover, because each of the font names is different, the user cannot see, for example, how a particular letter is rendered in one font verses another font, unless two simultaneously displayed fonts happen to include the same letter. In addition, conventional font preview mechanisms do not allow users to compare any two available fonts on the screen at the same time, but only those fonts that happen to be adjacent to one another in the order in which they are presented, typically alphabetically. Finally, existing preview systems are limited to fonts, but ignore other text attributes, such as size and kerning options.

### BRIEF DESCRIPTION OF THE DRAWINGS

FIG. 1 is a screen shot of a conventional font preview menu.

FIG. 2 is a screen shot of a font preview menu including multiple renditions of user-selected text in a plurality of different fonts.

FIG. 3 is a screen shot of an alternative font preview menu including multiple size options.

FIG. 4 is a screen shot of a kerning preview menu.

FIG. 5 is a screen shot of a comparison area within a font preview menu.

FIG. 6 is a screen shot of a font report.

FIG. 7 is a data flow diagram of interactions between one or more text-editing applications and a font control application.

FIG. 8 is a flowchart of a method for comparing and selecting fonts.

### DETAILED DESCRIPTION

Reference is now made to the figures in which like reference numerals refer to like elements. For clarity, the first digit of a reference numeral indicates the figure number in which the corresponding element is first used.

In the following description, numerous specific details of programming, software modules, user selections, network transactions, database queries, database structures, etc., are provided for a thorough understanding of the embodiments of the invention. However, those skilled in the art will recognize that the invention can be practiced without one or more of the specific details, or with other methods, components, materials, etc.

In some cases, well-known structures, materials, or operations are not shown or described in detail in order to avoid obscuring aspects of the invention. Furthermore, the described features, structures, or characteristics may be combined in any suitable manner in one or more embodiments.

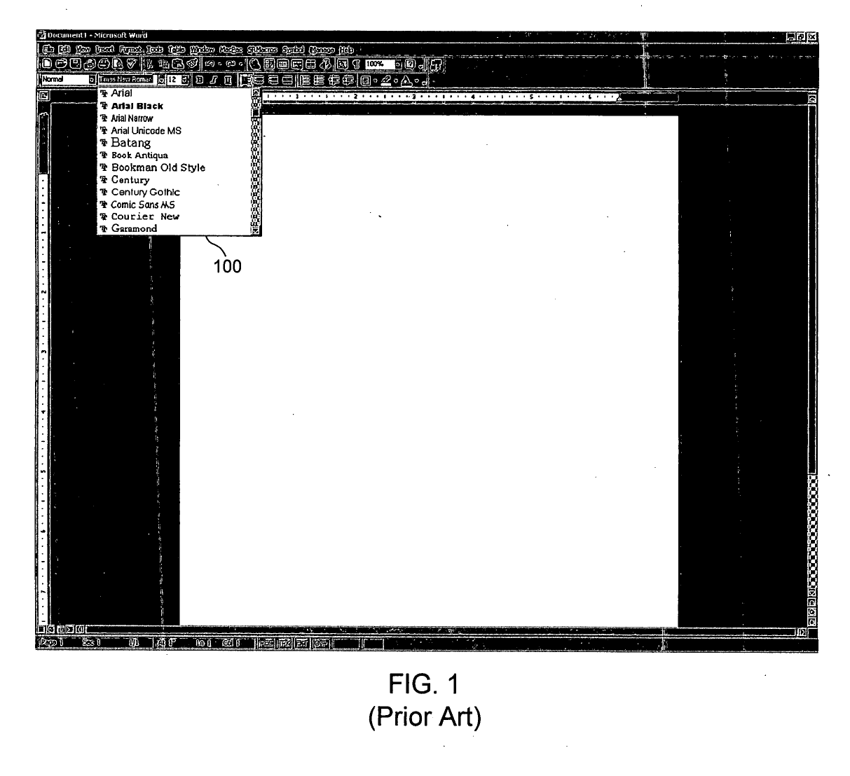

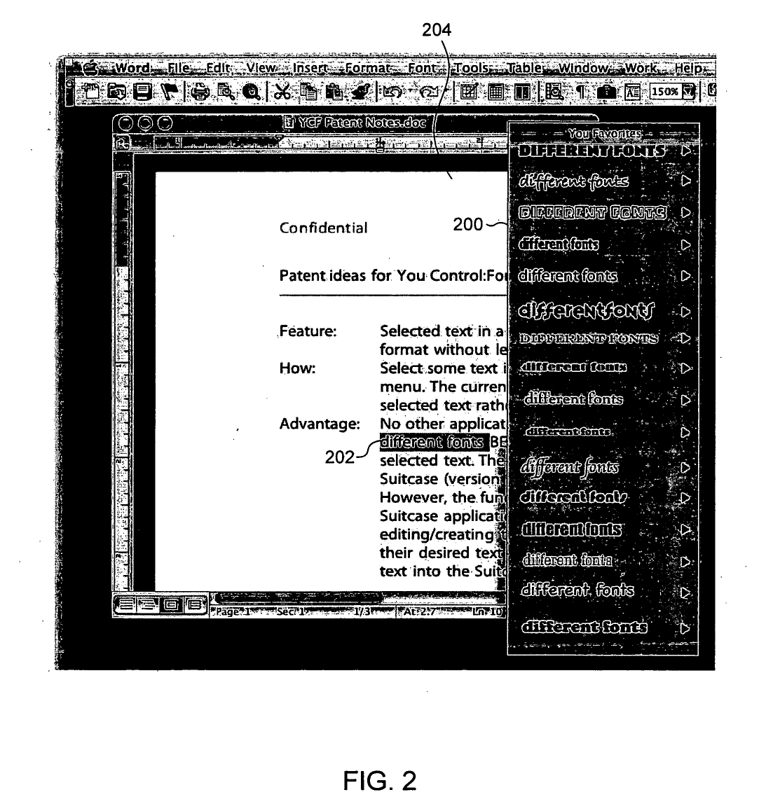

FIG. 2 illustrates a font preview menu 200 according to an embodiment of the invention that solves the foregoing problems and disadvantages. Rather than displaying each font name in a corresponding font, as in FIG. 1, the menu 200 automatically displays the same user-selected text 202 from a document 204 in a plurality of different fonts. As illustrated, the user-selected text 202 may be highlighted or otherwise selected by a mouse or keyboard using conventional techniques, after which the user may invoke a suitable command, such as a predefined keystroke, to display the font preview menu 200.

In one embodiment, the fonts presented in the font preview menu 200 are a pre-selected subset of the available fonts. A user may specify his or her “favorite” fonts using any suitable technique. Alternatively, the system may determine a user's favorite fonts based, for example, on frequency of usage. In still other embodiments, the displayed fonts may represent an alphabetical listing (or other arrangement) of all available fonts according to the names of the respective fonts.

As an example, FIG. 2 depicts a particular block of user-selected text 202 (“different fonts”) that is automatically rendered using sixteen different fonts. Any number of font possibilities may be displayed at the same time within practical limits imposed by the size of the screen, the screen resolution, the font size, etc. In some cases, the user-selected text 202 may be truncated in order to maximize the number of font options that may be displayed simultaneously. Customized truncation options, based on a fixed number of words or characters, may be defined in advance by a user. Additional font possibilities may be available off-screen, which may be revealed by scrolling through the font preview menu 200.

Each rendering of the user-selected text 202 in a different font may be presented in a what-you-see-is-what-you-get (WYSIWYG) format, allowing the user to see exactly how the user-selected text 202 will appear in the document 204. As illustrated, the font preview menu 200 may float above the word processor or other text-editing application. In various embodiments, the renditions of the user-selected text 202 may be ordered alphabetically according to the names of the underlying fonts, by frequency of usage, or in other ways.

Unlike standard approaches, the user-selected text 202 may be chosen to include a representative sample of letters or characters to allow meaningful comparison of the various fonts. Moreover, because the same text is automatically rendered in multiple fonts, the user may compare how particular characters appear in each font, which is not possible using the conventional approach depicted in FIG. 1. Advantageously, the multiple font options are displayed in response to a single action, unlike the usual method of applying multiple fonts to text in multiple actions.

In one implementation, the user may select a font by clicking on or otherwise selecting a corresponding rendition in the font preview menu 200 using the mouse or keyboard. In response, the selected font may be immediately applied to the user-selected text 202 within the document 204. In other words, the user-selected text 202 within the document 204 is changed from its original font to the font of the selected rendition.

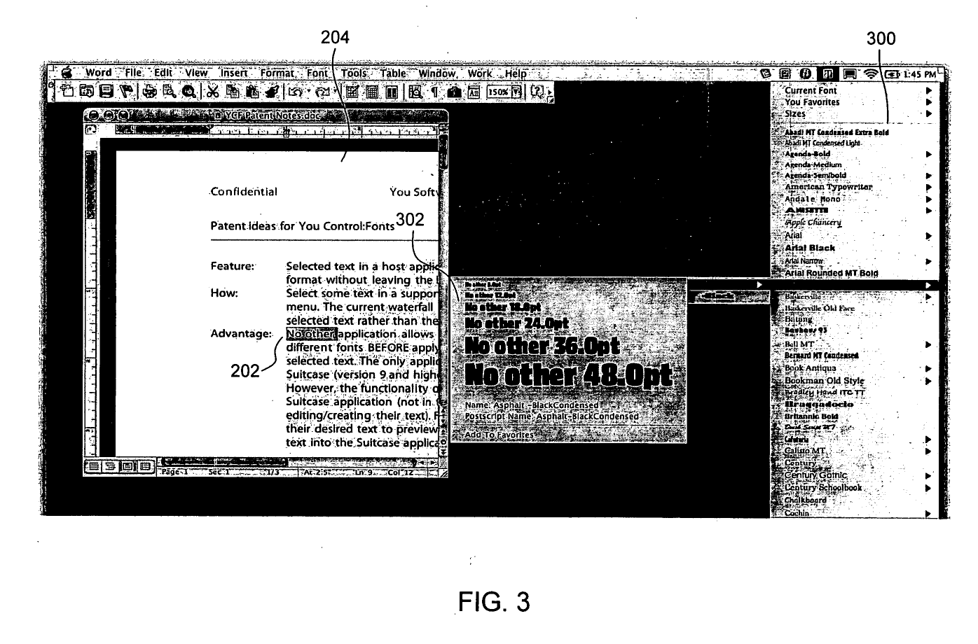

Referring to FIG. 3, an alternative font preview menu 300 may display the names of available (and possibly user-selected) fonts rendered in their respective fonts as described with reference to FIG. 1. However, when the user clicks on or otherwise selects a particular font name, a sub-menu 302 is presented which shows the user-selected text 202 rendered in the corresponding font. In one implementation, the user may easily compare different fonts by moving the mouse pointer up and down through the preview menu 300 or by pressing the up/down keys on the keyboard, which will automatically change the font of the user-selected text 202 within the sub-menu 302.

Different options for text attributes besides font (such as size or kerning) may also be automatically presented in a WYSIWYG format. For example, as shown in FIG. 3, the sub-menu 302 (or preview menu 300) may present a plurality of different size options. As illustrated, the user-selected text 202 may be automatically rendered in six different point sizes ranging from 9 to 48. Point size is a standard way for measuring the size of a typeface and is known to those of skill in the art. In the illustrated embodiment, a numerical indication of the point size (e.g., 36.0 pt) is displayed next to each rendition of the user-selected text 202. In one embodiment, the displayed point sizes may be defined in advance by the user.

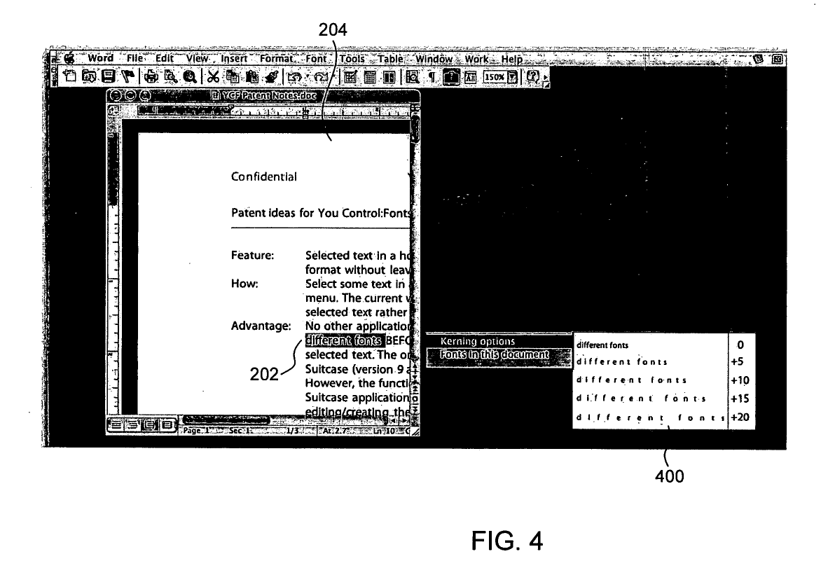

Similarly, as shown in FIG. 4, a kerning preview menu 400 may present the user-selected text 202 automatically rendered in a WYSIWYG format with different kerning options. Kerning relates to the spacing between characters. For example, a +5 kerning causes the characters of the user-selected text 202 to be spaced farther apart than a 0 kerning. In the illustrated example, kerning options are presented ranging from 0 to +20. The user may select one of the kerning options to change the kerning of the user-selected text 202 within the document 204.

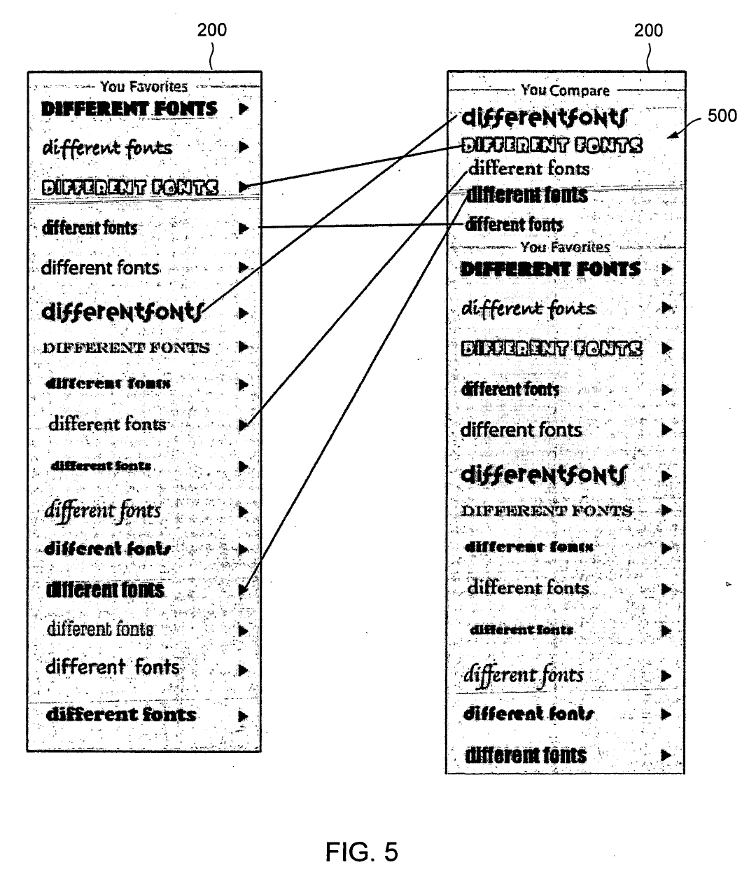

Referring to FIG. 5, the font preview menu 200 of FIG. 2 may be adapted to provide side-by-side comparison of selected fonts. One of the problems discussed with reference to the font preview menu 100 of FIG. 1 is that it does not allow comparisons between any two available fonts on the screen at the same time, but only those fonts that happen to be listed adjacent to one another. Typically, fonts names are listed alphabetically, as shown in FIG. 1. Hence, the font “Arial” cannot generally be compared in the font preview menu 100 with the font “Veranda.”

In one embodiment, the font preview menu 200 includes a comparison area 500 that may be used for side-by-side comparisons of any of the available fonts. The user can individually highlight or otherwise select renderings of the user-selected text 202 in different fonts from the font preview menu 200. In response to a particular command, such as a predefined keystroke, the renderings are copied (or moved) to the comparison area 500.

Unlike conventional approaches, the user does not need to apply the selected fonts to actual text to have them displayed in a “favorites” area at the top of the font listing. Indeed, the user may remain within the font preview menu 200, selecting fonts to compare side-by-side in the comparison area 500. Once the renderings of the user-selected text 202 are moved (or copied) to the comparison area 500, the user may select one of them to be applied to the user-selected text 202 within the document 204.

The above-described comparison feature may also be applied in the embodiment of FIG. 3. In that case, the renderings of the font names (as opposed to the user-selected text 202) will be copied (or moved) to the comparison area 500 to permit side-by-side comparison.

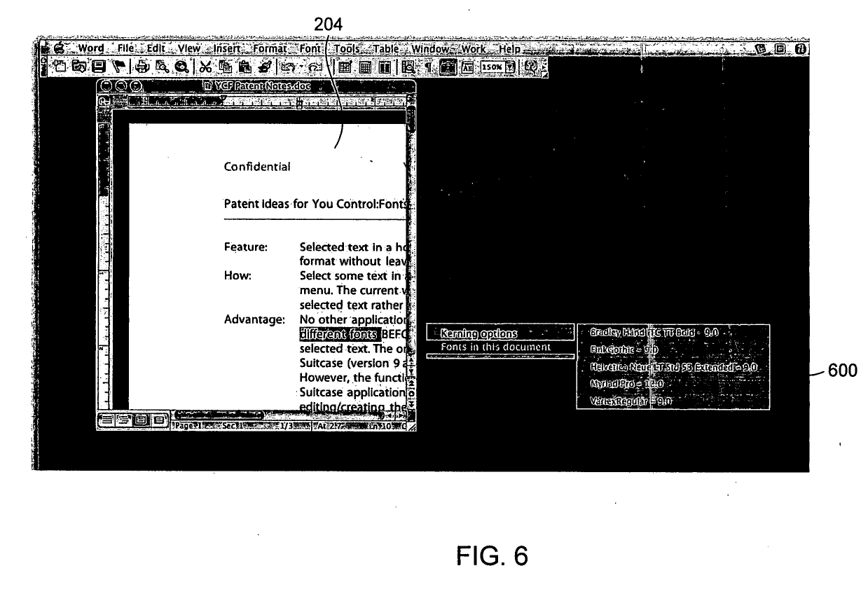

FIG. 6 illustrates a font report 600 that may be displayed in one embodiment to indicate all of the fonts currently in use within the document 204. Often, documents 204 employ a large number of fonts. For consistency and aesthetics, knowing what other fonts are being used in the document 204 may be beneficial to a user in deciding what font to select for a particular block of text.

As illustrated, the font report 600 may indicate the name of each font in addition to its size. In certain embodiments, the font names may be rendered in their respective fonts. Alternatively, or in addition, the font report 600 may include the user-selected text 202 (not shown) rendered in the fonts currently in use within the document 204.

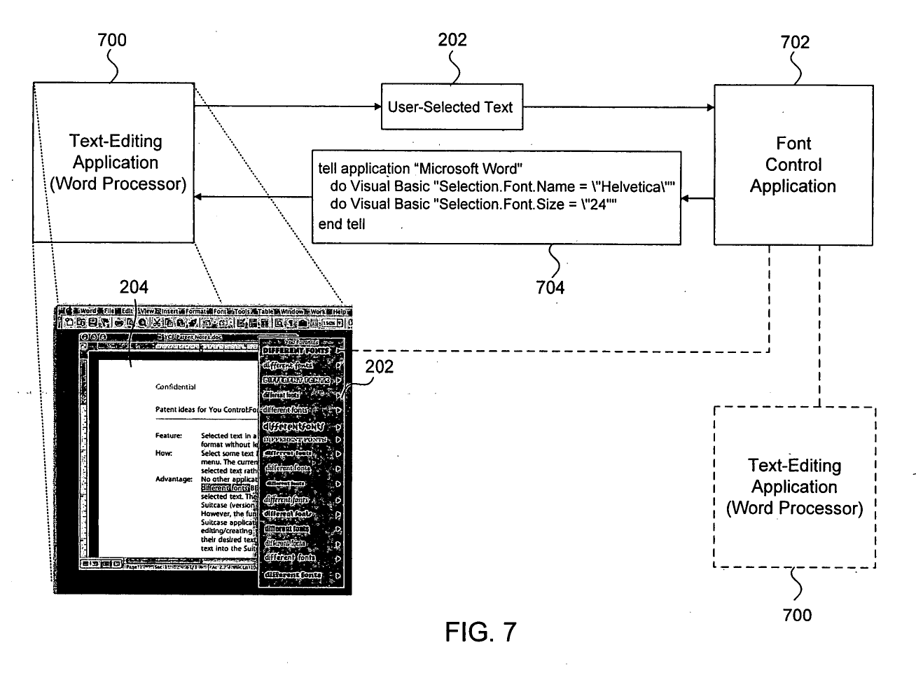

Referring to FIG. 7, the font preview menu 200 (as well as the other preview menus and sub-menus described above) may be internally generated by a text-editing application 700, such as a word processor, or alternatively, by a separate font control application 702. In the latter case, the font control application 702 may provide font previewing and selection services for a plurality of text-editing applications 702.

In operation, the font control application 702 detects a user selection or other highlighting of text within the a document 204 being edited by a text-editing application 700. A copy of the user-selected text 202 is then acquired by the font control application 702 using standard techniques.

As described above, the font control application 702 generates the font preview menu 200 including multiple renditions of the user-selected text 202 using different fonts. When the user selects one of these renditions, the font control application 702 instructs the appropriate text-editing application 700 to change the font of the user-selected text 202 within the document 204 to the font of the selected rendition.

The process of instructing the text-editing application 700 to change the font may occur in a number of different ways. In one embodiment, the font control application 702 sends scripting commands 704 to the text-editing application 700 via AppleScrip™ or Visual Basic™, for example. An example of scripting commands for changing the font and size of user-selected text 202 within Microsoft Word™ is as follows:

tell application “Microsoft Word″

do Visual Basic ″Selection.Font.Name = \″Helvetica\″″
do Visual Basic ″Selection.Font.Size = \″24″″

end tell

These scripting commands 704 target Microsoft Word™ and then issue two visual basic commands to set the font and size. Of course, different applications or operating systems would use different scripting commands 704 as known to those of skill in the art.

Another method for communication entails injecting a piece of code into the text-editing application 700 and then issuing commands to that piece of the code to change the font of the user-selected text 202. Code injection is the process of forcing a piece of code to be loaded into a target process without the knowledge of that process.

Mac OS X™ provides the capability of communicating with a secondary process via apple events. This communication method allows a programmer to send any desired data to another process provided the process knows about the data coming to it. Every process knows how to respond to the “kGetAETE” and “kGetAEUT” of the kASAppleScriptSuite class of events. These events force the operating system to load all modules of code of type “osax” into its address space. The “osax” modules reside in a specific folder that the operating system knows about. Any time the font control application 702 wants to change the font of the target process, it first makes sure its code has been injected by sending the above apple events. The font control application 702 then sends a message via apple events to its injected code telling it to change the font to the one the user has chosen. After the injected code receives the “change font” message, it looks through all of the menus trying to find an item in the menu that matches the name of the font to be changed. If the font the user wants to change is found, the injected code sends an event to the text-editing application 700 telling it to choose that menu item. The text-editing application 700 then changes the current font to the user-chosen font.

The above-described process may also be used to change other attributes of the user-selected text 202, such as kerning. In addition, other techniques for communicating between the font control application 702 and the text-editing application 700 may be used as known to those of skill in the art.

One benefit of a separate font control application 702 is that configuration settings may be consistent across a plurality of text-editing applications 700. For example, a user's selection of favorite fonts, size ranges, or fonts to be compared within the comparison area 500 may be used in connection with each text-editing application 700. Thus, a user does not need to learn a different font selection interface for multiple applications 700 and does not need to individually configure each interface to have similar settings.

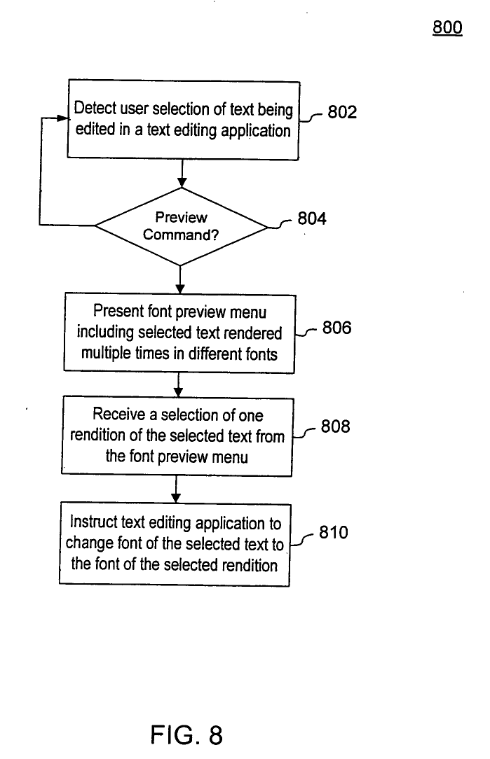

The foregoing process is further illustrated in FIG. 8, which is a flowchart of a method 800 for comparing and selecting fonts. At block 802, a font control application (702) detects a user selection of text being edited in a text-editing application (700). At block 804, the font control application (702) determines whether a preview command has been received. If not, control returns to block 802. Otherwise, control passes to block 806, at which the font control application (702) presents a font preview menu (200) including the user-selected text (202) automatically rendered multiple times in different fonts.

In block 808, the font control application (702) receives a user selection of one rendition of the selected text (202) from the font preview menu (200). In response, at block 810, the font control application (702) instructs the text-editing application (700) to change the font of the selected text (202) to the font of the selected rendition.

While specific embodiments and applications of the present invention have been illustrated and described, it is to be understood that the invention is not limited to the precise configuration and components disclosed herein. Various modifications, changes, and variations apparent to those of skill in the art may be made in the arrangement, operation, and details of the methods and systems of the present invention disclosed herein without departing from the spirit and scope of the present invention.

Embodiments of the invention may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware.

Embodiments of the present invention may also be provided as a computer program product including a machine-readable medium having stored thereon instructions that may be used to program a computer (or other electronic device) to perform processes described herein. The machine-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

What is claimed is:

1. A method comprising:
receiving a selection of text being edited in an application; and
in response to a first command, presenting a font preview menu including the selected text automatically rendered multiple times in different fonts.

2. The method of claim 1, further comprising:
receiving a selection of one rendition of the selected text from the font preview menu; and
changing a font of the selected text in the application to the font of the selected rendition.

3. The method of claim 2, wherein receiving a selection of one rendition of the selected text comprises detecting the rendition being dragged from the font preview menu onto the selected text.

4. The method of claim 1, further comprising:
receiving a selection of one rendition of the selected text from the font preview menu; and
in response to a second command, displaying the selected rendition in a comparison area of the font preview menu next to one or more other renditions so selected.

5. The method of claim 3, wherein the comparison area is located at a top portion of the font preview menu.

6. The method of claim 1, further comprising:
in response to a second command, presenting a kerning preview menu including the selected text being rendered multiple times with a plurality of different kerning options.

7. The method of claim 6, further comprising:
receiving a selection of one rendition of the selected text from the kerning preview menu; and
changing a kerning of the selected text in the application to the kerning of the selected rendition from the kerning preview menu.

8. The method of claim 1, further comprising:
in response to a second command, displaying a font report including an indication of each font of text being edited by the application.

9. The method of claim 8, wherein each indication comprises a text name, the method further comprising:
rendering the text name of each indication of a font in the respective font for that indication.

10. The method of claim 1, wherein presenting comprises truncating the user-selected text prior to being displayed in the font preview menu.

11. The method of claim 10, further comprising:
receiving customization settings from a user for truncating the user-selected text in the font preview menu.

12. The method of claim 1, wherein presenting the font preview menu comprises presenting a contextual menu.

13. The method of claim 1, wherein presenting the font preview menu comprises presenting a menu of a separate font control application.

14. The method of claim 13, further comprising:
sending scripting commands from the font control application to the text-editing application, the scripting commands causing the text-editing application to change a font of the selected text to a font of a selected rendition.

15. The method of claim 13, further comprising:
using the font control application to inject code into the text-editing application, wherein the code is to cause the text-editing application to change a font of the selected text to a font of a selected rendition.

16. The method of claim 1, wherein presenting a font preview menu comprises presenting each rendition of the selected text in a WYSIWIG format.

17. The method of claim 1, wherein the different fonts are pre-selected by a user.

18. The method of claim 1, further comprising ordering the renditions of the selected text in the font preview menu according to frequency of use of the corresponding fonts.

19. The method of claim 1, further comprising ordering the renditions of the selected text in the font preview menu alphabetically according to names of the corresponding fonts.

20. The method of claim 1, wherein presenting a font preview menu comprises rendering different sized versions of the selected text for at least one font.

21. A method comprising:
receiving a selection of text being edited in an application; and
in response to a user command, presenting a kerning preview menu including the selected text being automatically rendered multiple times with a plurality of different kerning options.

22. The method of claim 21, further comprising:
receiving a selection of one rendition of the selected text from the kerning preview menu; and
changing a kerning of the selected text in the application to the kerning of the selected rendition from the kerning preview menu.

23. The method of claim 22, wherein receiving a selection of one rendition of the selected text comprises detecting the rendition being dragged from the Kerning preview menu onto the selected text.

24. A method comprising:
detecting at a font control application a user selection of text being edited in a first text-editing application;
in response to a single user command, presenting a font preview menu including the selected text automatically rendered multiple times in a plurality of fonts;
receiving a selection of one rendition of the selected text from the font preview menu; and
instructing the first text-editing application to change a font of the selected text to the font of the selected rendition.

25. The method of claim 24, wherein instructing comprises sending scripting commands to the first text-editing application, the scripting commands causing the first text-editing application to change a font of the selected text to the font of the selected rendition.

26. The method of claim 24, wherein instructing comprises injecting code into the first text-editing application, wherein the code is to cause the first text-editing application to change a font of the selected text to the font of the selected rendition.

27. The method of claim 24, further comprising:
detecting at the font control application a second user selection of text being edited in a second text-editing application;
in response to a user command, presenting the font preview menu including the second selected text automatically rendered multiple times in the same plurality of fonts;
receiving a selection of one rendition of the second selected text from the font preview menu; and
instructing the second text-editing application to change a font of the second selected text to the font of the selected rendition.

28. A method comprising:
receiving a selection of text being edited in an application;
presenting a first menu including names of at least a subset of available fonts;
receiving a selection of a font from the first menu;
in response to a selection of a font, presenting a second menu including the selected text automatically rendered multiple times using the selected font in a plurality of different sizes;
receiving a selection of one of the renditions of the selected text;
setting a font of the selected text in the application to the selected font from the first menu; and
setting a size of the selected text in the application to the size of the selected rendition from the second menu.

29. The method of claim 28, wherein presenting comprises rendering each name of the at least a subset of available fonts in its respective font.

30. The method of claim 28, wherein the at least a subset of available fonts is pre-selected by a user.

31. A computer program product comprising a computer-readable medium including: program code for receiving a selection of text being edited in an application; and
program code for presenting, in response to a first command, a font preview menu including the selected text automatically rendered multiple times in different fonts.

32. The computer program product of claim 31, wherein the computer-readable medium further includes:
program code for receiving a selection of one rendition of the selected text from the font preview menu; and
program code for changing a font of the selected text in the application to the font of the selected rendition.

33. The computer program product of claim 32, wherein the program code for receiving a selection of one rendition of the selected text comprises program code for detecting the rendition being dragged from the font preview menu onto the selected text.

34. The computer program product of claim 31, wherein the computer-readable medium further includes:
program code for receiving a selection of one rendition of the selected text from the font preview menu; and
program code for displaying, in response to a second command, the selected rendition in a comparison area of the font preview menu next to one or more other renditions so selected.

35. The computer program product of claim 33, wherein the comparison area is located at a top portion of the font preview menu.

36. The computer program product of claim 31, wherein the computer-readable medium further includes:
program code for presenting, in response to a second command, a kerning preview menu including the selected text being rendered multiple times with a plurality of different kerning options.

37. The computer program product of claim 36, wherein the computer-readable medium further includes:
program code for receiving a selection of one rendition of the selected text from the kerning preview menu; and
program code for changing a kerning of the selected text in the application to the kerning of the selected rendition from the kerning preview menu.

38. The computer program product of claim 31, wherein the computer-readable medium further includes:
in response to a second command, displaying a font report including an indication of each font of text being edited by the application.

39. The computer program product of claim 38, wherein each indication comprises a text name, and wherein the computer-readable medium further includes:
program code for rendering the text name of each indication of a font in the respective font for that indication.

40. The computer program product of claim 31, wherein the program code for presenting comprises program code for truncating the user-selected text prior to being displayed in the font preview menu.

41. The computer program product of claim 40, wherein the computer-readable medium further includes:
program code for receiving customization settings from a user for truncating the user-selected text in the font preview menu.

42. The computer program product of claim 31, wherein the font preview menu is a contextual menu.

43. The computer program product of claim 31, wherein the font preview menu is a menu of a separate font control application.

44. The computer program product of claim 43, wherein the computer-readable medium further includes:
sending scripting commands from the font control application to the text-editing application, the scripting commands causing the text-editing application to change a font of the selected text to a font of a selected rendition.

45. The computer program product of claim 43, wherein the computer-readable medium further includes:
using the font control application to inject code into the text-editing application, wherein the code is to cause the text-editing application to change a font of the selected text to a font of a selected rendition.

46. The computer program product of claim 31, wherein presenting a font preview menu comprises presenting each rendition of the selected text in a WYSIWIG format.

47. The computer program product of claim 31, wherein the different fonts are pre-selected by a user.

48. The computer program product of claim 31, further comprising ordering the renditions of the selected text in the font preview menu according to frequency of use of the corresponding fonts.

49. The computer program product of claim 31, further comprising ordering the renditions of the selected text in the font preview menu alphabetically according to names of the corresponding fonts.

50. The computer program product of claim 31, wherein presenting a font preview menu comprises rendering different sized versions of the selected text for at least one font.

51. A computer program product comprising a computer-readable medium including: program code for receiving a selection of text being edited in an application; and
program code for presenting, in response to a user command, a kerning preview menu including the selected text being automatically rendered multiple times with a plurality of different kerning options.

52. The computer program product of claim 21, wherein the computer-readable medium further includes:
program code for receiving a selection of one rendition of the selected text from the kerning preview menu; and
program code for changing a kerning of the selected text in the application to the kerning of the selected rendition from the kerning preview menu.

53. The computer program product of claim 22, wherein the program code for receiving a selection of one rendition of the selected text comprises program code for detecting the rendition being dragged from the kerning preview menu onto the selected text.

54. A computer program product comprising a computer-readable medium including:
program code for detecting at a font control application a user selection of text being edited in a first text-editing application;
program code for presenting, in response to a single user command, a font preview menu including the selected text automatically rendered multiple times in a plurality of fonts;
program code for receiving a selection of one rendition of the selected text from the font preview menu; and
program code for instructing the first text-editing application to change a font of the selected text to the font of the selected rendition.

55. The computer program product of claim 24, wherein the program code for instructing comprises program code for sending scripting commands to the first text-editing application, the scripting commands causing the first text-editing application to change a font of the selected text to the font of the selected rendition.

56. The computer program product of claim 24, wherein the program code for instructing comprises program code for injecting code into the first text-editing application, wherein the code is to cause the first text-editing application to change a font of the selected text to the font of the selected rendition.

57. The computer program product of claim 54, wherein the computer-readable medium further includes:

27. The method of claim 24, wherein the computer-readable medium further includes:
program code for detecting at the font control application a second user selection of text being edited in a second text-editing application;
program code for presenting, in response to a user command, the font preview menu including the second selected text automatically rendered multiple times in the same plurality of fonts;
program code for receiving a selection of one rendition of the second selected text from the font preview menu; and
program code for instructing the second text-editing application to change a font of the second selected text to the font of the selected rendition.

58. A computer program product comprising a computer-readable medium including: program code for receiving a selection of text being edited in an application;
program code for presenting a first menu including names of at least a subset of available fonts;
program code for receiving a selection of a font from the first menu;
program code for presenting, in response to a selection of a font, a second menu including the selected text automatically rendered multiple times using the selected font in a plurality of different sizes;
program code for receiving a selection of one of the renditions of the selected text;
program code for setting a font of the selected text in the application to the selected font from the first menu; and
program code for setting a size of the selected text in the application to the size of the selected rendition from the second menu.

59. The computer program product of claim 28, wherein the program code for presenting a first menu comprises program code for rendering each name of the at least a subset of available fonts in its respective font.

60. The computer program product of claim 28, wherein the program code for presenting a second menu comprises program code for displaying with each rendition of the selected text a numerical indication of the size.

61. A user interface for comparing and selecting attributes of text within a document comprising:
a font preview menu including a plurality of selectable renditions of user-identified text from the document in a plurality of different fonts; and
a selection mechanism for allowing a user to choose one of the renditions in order to apply the associated font to the user-identified text in the document.

62. The user interface of claim 61, wherein the font preview menu includes a comparison area for displaying user-selected renditions for side-by-side comparison.

63. The user interface of claim 61, wherein the comparison area is located at a top portion of the font preview menu.

64. The user interface of claim 61, further comprising:
a kerning preview menu including a plurality of selectable renditions of the user-identified text using a plurality of different kerning options.

65. The user interface of claim 61, further comprising:
a size preview menu including a plurality of selectable renditions of the user-identified text using a plurality of different size options.

66. A system for comparing and selecting text attributes comprising:
a text-editing application; and
a font control application, in communication with the text-editing application, for detecting a user selection of text being edited in the text-editing application and presenting a font preview menu including the selected text automatically rendered multiple times in different fonts.

67. The system of claim 66, wherein the font control application is to receive a selection of one rendition of the selected text from the font preview menu, after which the font control application is to instruct the text-editing application to change a font of the selected text to the font of the selected rendition.

68. The method of claim 24, wherein the font control application is to instruct the text-editing application by sending scripting commands for causing the text-editing application to change a font of the selected text.

69. The method of claim 24, wherein the font control application is to instruct the text-editing application by injecting code into the text-editing application to cause the text-editing application to change a font of the selected text.
